(19) United States
(12) Patent Application Publication
(10) Pub. No.: US 2026/0288366 A1
(43) Pub. Date: Sep. 24, 2026

(54) STORAGE DEVICE CONVERTING AND STORING DATA UNITS AND FLAG SETS, AND OPERATING METHOD THEREOF

(71) Applicant: SK hynix Inc., Gyeonggi-do (KR)

(72) Inventor: Eui Dong LEE, Gyeonggi-do (KR)

(21) Appl. No.: 19/278,798

(22) Filed: Jul. 24, 2025

(30) Foreign Application Priority Data
Mar. 18, 2025 (KR) 10-2025-0034324

(51) Int. Cl. G06F 3/06

(52) U.S. Cl. CPC G06F 3/0655; G06F 3/0604; G06F 3/0679

(57) ABSTRACT

A storage device may generate a conversion flag based on a first flag set including N number of first flags respectively corresponding to N number of data units, and a second flag set including N number of second flags respectively corresponding to the N number of data units, may store at least one of a) one or more target data units among the N number of data units, b) the first flag set and c) the second flag set in a data area, and may store the conversion flag in a flag area.

### CROSS-REFERENCE TO RELATED APPLICATION

The present application claims priority under 35 U.S.C. § 119(a) to Korean Patent Application No. 10-2025-0034324 filed on Mar. 18, 2025, which is incorporated herein by reference in its entirety.

### BACKGROUND

### 1. Technical Field

Embodiments of the present disclosure relate to a storage device which converts and stores data units and flag sets, and an operating method thereof.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

A storage device may write data to a memory by the unit of a preset page size (e.g., 4 KB). However, an external device may transmit read and write requests for data units each of a size (e.g., 512 bytes) smaller than the page size to the storage device.

Therefore, in order to process the read and write requests for the data units, the storage device needs to separately manage information on data units included in one page through additional data.

### SUMMARY

Embodiments of the present disclosure are directed to providing a storage device capable of efficiently storing additional data for managing information on data units write-requested from a host, and an operating method thereof.

Advantages of embodiments of the present disclosure are not limited to those set forth herein, and other unmentioned advantages would be apparent to one of ordinary skill in the art from the following description.

In an embodiment of the present disclosure, a storage device may include a memory including a data area and a flag area corresponding to the data area; and a controller configured to generate a conversion flag based on a first flag set and a second flag set, the first flag set including N number of first flags respectively corresponding to N number of data units, the second flag set including N number of second flags respectively corresponding to the N number of data units, N being a natural number of 2 or more; store at least one of a) one or more target data units among the N number of data units, b) the first flag set, and c) the second flag set in the data area; and store the conversion flag in the flag area.

In an embodiment of the present disclosure, an operating method of a storage device may include generating a first flag set and a second flag set, the first flag set including N number of first flags respectively corresponding to N number of data units, the second flag set including N number of second flags respectively corresponding to the N number of data units, N being a natural number of 2 or more; generating a conversion flag based on the first flag set and the second flag set; storing at least one of a) one or more target data units among the N number of data units, b) the first flag set and c) the second flag set in a data area; and storing the conversion flag in a flag area corresponding to the data area.

In an embodiment of the present disclosure, a storage device may include a data area, and a flag area configured to store metadata corresponding to data stored in the data area. The storage device is configured to generate a first flag set and a second flag set, the first flag set including N number of first flags respectively corresponding to N number of data units, the second flag set including N number of second flags respectively corresponding to the N number of data units, N being a natural number of 2 or more; generate a conversion flag based on the first flag set and the second flag set; store at least one of a) one or more target data units among the N number of data units, b) the first flag set and c) the second flag set in a data area; and store the conversion flag in a flag area corresponding to the data area.

According to embodiments of the present disclosure, a storage device can efficiently store additional data for managing information on data units write-requested from a host.

The advantages of the embodiments of the present disclosure are not limited to the foregoing advantages, and other advantages will be apparent to one of ordinary skill in the art from the following detailed description.

### BRIEF DESCRIPTION OF THE DRAWINGS

The embodiments of the present disclosure will be more fully understood from the following detailed description and the accompanying drawings, which are provided for illustration only and are not intended to limit the embodiments.

FIG. 1 is a schematic configuration diagram of a storage device according to an embodiment of the present disclosure.

FIG. 2 is a block diagram schematically illustrating a memory of FIG. 1.

FIG. 3 is a diagram illustrating the schematic operation of the storage device according to an embodiment of the present disclosure.

FIG. 4 is a diagram for describing an operation of the storage device determining a first flag set, according to an embodiment of the present disclosure.

FIG. 5 is a diagram for describing an operation of the storage device determining a second flag set, according to an embodiment of the present disclosure.

FIG. 6 is a flowchart for describing an operation of the storage device determining the value of a conversion flag, according to an embodiment of the present disclosure.

FIG. 7 is a diagram for describing an operation of the storage device storing the first flag set and the second flag set in a data area, according to an embodiment of the present disclosure.

FIG. 8 is a diagram for describing an operation of the storage device storing target data units in the data area, according to an embodiment of the present disclosure.

FIG. 9 is a diagram for describing an operation of the storage device storing N number of data units in the data area, according to an embodiment of the present disclosure.

FIG. 10 is a diagram for describing an operation of the storage device restoring the first flag set, the second flag set and the N number of data units, according to an embodiment of the present disclosure.

FIG. 11 is a diagram for describing another operation of the storage device restoring the first flag set, the second flag set and the N number of data units, according to an embodiment of the present disclosure.

FIG. 12 is a diagram showing an operating method of a storage device according to an embodiment of the present disclosure.

### DETAILED DESCRIPTION

Hereinafter, embodiments of the present disclosure are described in detail with reference to the accompanying drawings. In assigning reference numerals to components of each drawing, the same components may be assigned the same numerals even when they are shown on different drawings. When it is determined that the subject matter of the present disclosure will be unclear, the details of the known art or functions may be skipped. As used herein, when a component “includes,” “has,” or “is composed of” another component, the component may add other components unless the term “only” precedes “includes”, “has”, or “is composed of”. As used herein, the singular forms “a”, “an” and “the” are intended to include the plural forms as well, unless the context clearly indicates otherwise.

Labels such as “first,” “second,” “A,” “B,” “(a),” and “(b),” may be used in describing the components of the present disclosure. These labels are provided merely to distinguish a component from another, and the essence, order, or number of the components are not limited by the labels.

In describing the positional relationship between components, when two or more components are described as “connected”, “coupled” or “linked”, the two or more components may be directly “connected”, “coupled” or “linked”, or another component may intervene. Here, the other component may be included in one or more of the two or more components that are “connected”, “coupled” or “linked” to each other.

When terms such as, e.g., “after”, “next to”, “after”, and “before”, are used to describe the temporal flow relationship related to components, operation methods, and fabricating methods, it may include a non-continuous relationship unless the term “immediately” or “directly” is also used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the present disclosure are described in detail with reference to the accompanying drawings.

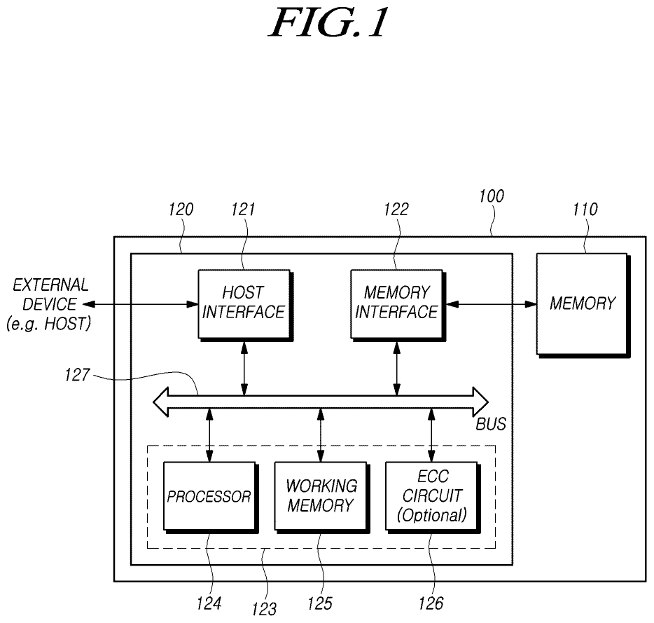

FIG. 1 is a schematic configuration diagram of a storage device 100 according to an embodiment of the present disclosure.

Referring to FIG. 1, the storage device 100 may include a memory 110 that stores data and a controller 120 that controls the memory 110.

The memory 110 may include a plurality of memory blocks, and operate under the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. The memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience, descriptions will describe the controller 120 and the host as devices that are separated from each other.

Referring to FIG. 1, the controller 120 may include a memory interface 122 and a control circuit 123, and may further include a host interface 121.

The host interface 121 may provide an interface for communication with the host. For example, the host interface 121 may provide an interface that uses at least one from among various communication standards or interfaces such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is, the memory interface 122 may provide an interface between the memory 110 and the controller 120 under the control of the control circuit 123.

The control circuit 123 may perform the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of the present disclosure will be described as implementing a processor 124 that executes firmware in which the corresponding operation is defined.

Firmware is a program to be executed in the storage device 100 to drive the storage device 100, and may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata is data for managing the memory 110, and may include for example, management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). The controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. When the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

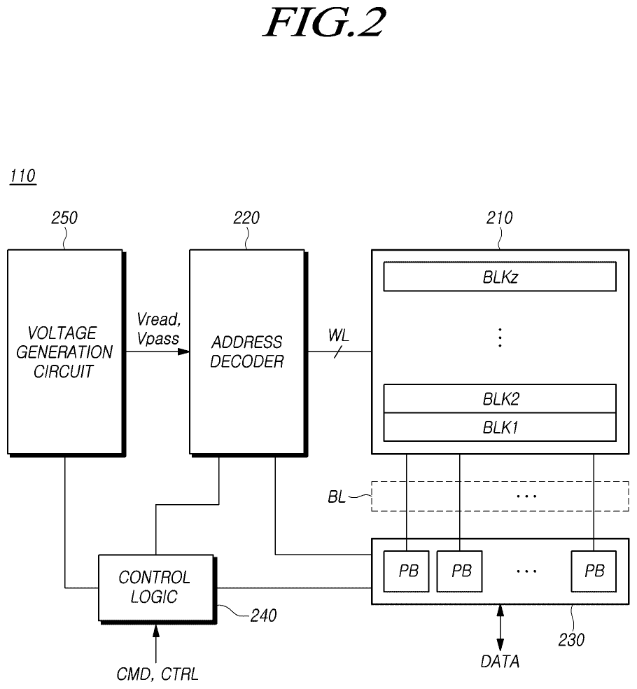

Hereinbelow, the memory 110 will be described in further detail with reference to FIG. 2.

FIG. 2 is a block diagram schematically illustrating a memory 110 of FIG. 1.

Referring to FIG. 2, the memory 110 according to an embodiment of the present disclosure may include a memory cell array 210, an address decoder 220, a read and write circuit 230, a control logic 240, and a voltage generation circuit 250.

The memory cell array 210 may include a plurality of memory blocks BLK1 to BLKz, where z is a natural number of 2 or greater.

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may operate under the control of the control logic 240.

The address decoder 220 may receive an address through an input/output buffer in the memory 110. The address decoder 220 may decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. In an embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another embodiment, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

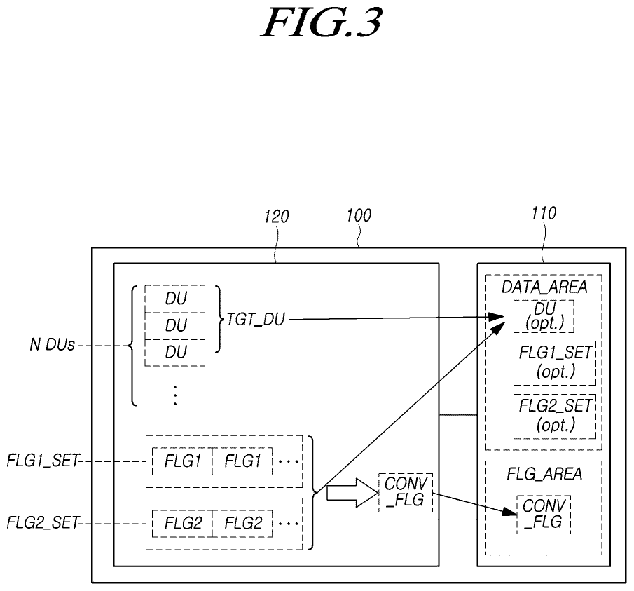

FIG. 3 is a diagram illustrating the schematic operation of the storage device 100 according to an embodiment of the present disclosure.

Referring to FIG. 3, the storage device 100 may include the memory 110 and the controller 120.

The memory 110 may include a data area DATA_AREA and a flag area FLG_AREA corresponding to the data area DATA_AREA.

The data area DATA_AREA is an area capable of storing data. For example, the data area DATA_AREA may include one or more memory blocks. For another example, the data area DATA_AREA may include one or more pages. The data area DATA_AREA may store data of a preset size (e.g., 4 KB).

The flag area FLG_AREA is an area capable of storing flags corresponding to data stored in the data area DATA_AREA. For example, the flag area FLG_AREA may be an area that stores metadata corresponding to data stored in the data area DATA_AREA. For another example, the flag area FLG_AREA may be a dedicated memory block that is allocated to store flags among a plurality of memory blocks included in the memory 110.

The controller 120 may determine data to be stored in the data area DATA_AREA and the flag area FLG_AREA based on N number of data units DU, where N is a natural number of 2 or more, a first flag set FLG1_SET and a second flag set FLG2_SET.

Each of the N number of data units DU may be data with a preset size (e.g., 512 bytes). A data unit may be a minimum unit of data read-requested or write-requested from the outside (e.g., a host) of the storage device 100. A data unit may also be referred to as a term such as sector or segment.

At least one of the N number of data units DU may be included in one data chunk. The unit size of data to be written to the data area DATA_AREA may be the size of a data chunk. Data units included in one data chunk may be written to the data area DATA_AREA at once, and may be read from the data area DATA_AREA at once.

For example, eight data units DU each having the size of 512 bytes may constitute a data chunk of a 4 KB size. A data chunk of a 4 KB size may be written to the data area DATA_AREA at once, and a data chunk of a 4 KB size stored in the data area DATA_AREA may be read at once.

The first flag set FLG1_SET may include N number of first flags FLG1 corresponding to the N number of data units DU, respectively. For example, each first flag FLG1 may be 1-bit data (1 or 0), and the first flag set FLG1_SET may be an N-bit bitmap (e.g., 0b11111111).

For example, the value of the first flag FLG1 may be a first value (e.g., 1) or a second value (e.g., 0). The first value and the second value are different from each other.

The second flag set FLG2_SET may include N number of second flags FLG2 corresponding to the N number of data units DU, respectively. For example, each second flag FLG2 may be 1-bit data (1 or 0), and the second flag set FLG2_SET may be an N-bit bitmap (e.g., 0b11111111).

For example, the value of the second flag FLG2 may be a third value (e.g., 1) or a fourth value (e.g., 0). The third value and the fourth value are different from each other. The third value may be the same as one of the first value and the second value, and the fourth value may be the same as the other of the first value and the second value.

The controller 120 may determine a conversion flag CONV_FLG based on the first flag set FLG1_SET and the second flag set FLG2_SET. The size of the conversion flag CONV_FLG may be smaller than the sum of the size of the first flag set FLG1_SET and the size of the second flag set FLG2_SET.

For example, the controller 120 may generate the conversion flag CONV_FLG of a 1 bit size based on the first flag set FLG1_SET of an 8 bit size and the second flag set FLG2_SET of an 8 bit size. For example, the controller 120 may determine the conversion flag CONV_FLG as 1 when a result of executing an AND operation between the first flag set FLG1_SET of an 8 bit size and the second flag set FLG2_SET of an 8 bit size is the same as a reference value (e.g., 0xFF), and may determine the conversion flag CONV_FLG as 0 when the result is different from the reference value.

The controller 120 may store at least one of 1) one or more target data units TGT_DU among the N number of data units DU, 2) the first flag set FLG1_SET and 3) the second flag set FLG2_SET in the data area DATA_AREA.

The controller 120 may store the conversion flag CONV_FLG in the flag area FLG_AREA.

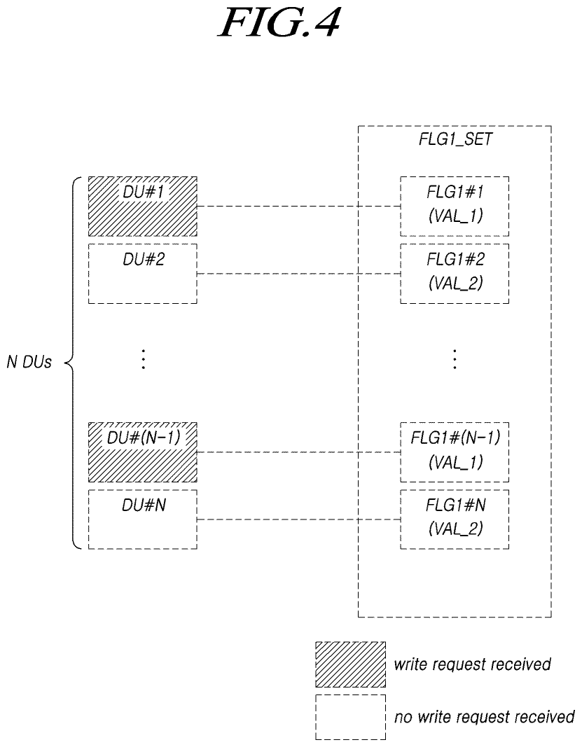

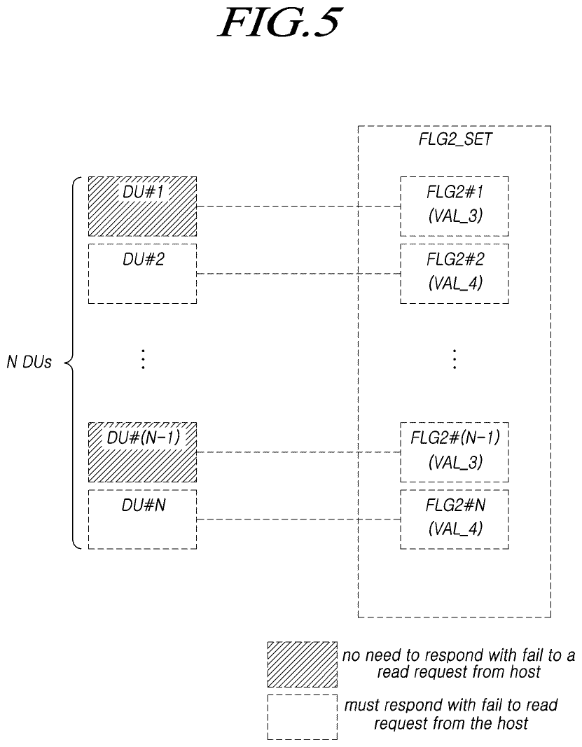

In embodiments of the present disclosure, the first flag set FLG1_SET and the second flag set FLG2_SET may be determined depending on the characteristics of the N number of data units DU. Hereinafter, this will be described in detail with reference to FIG. 4 and FIG. 5.

FIG. 4 is a diagram for describing an operation of the storage device 100 determining the first flag set FLG1_SET, according to an embodiment of the present disclosure.

In embodiments of the present disclosure, the controller 120 of the storage device 100 may set the value of a first flag FLG1 corresponding to a data unit write-requested from the outside (e.g., the host) of the storage device 100 among the N number of data units DU to a first value VAL_1. The data unit write-requested from the outside of the storage device 100 may be read by the outside of the storage device 100. The data unit write-requested from the outside of the storage device 100 may be referred to as a valid data unit.

The controller 120 may set the value of a first flag FLG1 corresponding to a data unit not write-requested from the outside of the storage device 100 among the N number of data units DU to a second value VAL_2. The data unit not write-requested from the outside of the storage device 100 is not subsequently read by the outside of the storage device 100, and thus, does not need to be stored in the data area DATA_AREA. The data unit not write-requested from the outside of the storage device 100 may also be referred to as a dummy data unit or an invalid data unit.

In FIG. 4, the values of first flags FLG1#1 and FLG1#N-1 corresponding to data units DU#1 and DU#N-1, respectively, write-requested from the outside of the storage device 100 are the first value VAL_1.

The values of first flags FLG1#2 and FLG1#N corresponding to data units DU#2 and DU#N, respectively, not write-requested from the outside of the storage device 100 are the second value VAL_2.

FIG. 5 is a diagram for describing an operation of the storage device 100 determining the second flag set FLG2_SET, according to an embodiment of the present disclosure.

In embodiments of the present disclosure, the controller 120 of the storage device 100 may set the value of a second flag FLG2 corresponding to a data unit for which a fail does not necessarily need to be responded to a read request from the outside (e.g., the host) of the storage device 100 among the N number of data units DU to a third value VAL_3. In this case, the storage device 100 should store the corresponding data unit in the data area DATA_AREA, and when a read operation on the corresponding data unit is normally executed, should respond a read success to the outside of the storage device 100.

The data unit for which a fail does not necessarily need to be responded to a read request from the outside of the storage device 100 may be referred to as a correctable data unit.

The controller 120 may set the value of a second flag FLG2 corresponding to a data unit for which a fail necessarily needs to be responded to a read request from the outside of the storage device 100 among the N number of data units DU to a fourth value VAL_4. In this case, the storage device 100 should respond a fail to the outside of the storage device 100 regardless of a read operation on the corresponding data unit. Therefore, the storage device 100 does not need to store the corresponding data unit in the data area DATA_AREA.

The data unit for which a fail necessarily needs to be responded to a read request from the outside of the storage device 100 may be referred to as an uncorrectable data unit.

In FIG. 5, the values of second flags FLG2#1 and FLG2#N-1 corresponding to data unit DU#1 and DU#N-1, respectively, for which fails do not necessarily need to be responded to a read request from the outside of the storage device 100 are the third value VAL_3.

The values of second flags FLG2#2 and FLG2#N corresponding to data unit DU#2 and DU#N, respectively, for which fails necessarily need to be responded to a read request from the outside of the storage device 100 are the fourth value VAL_4.

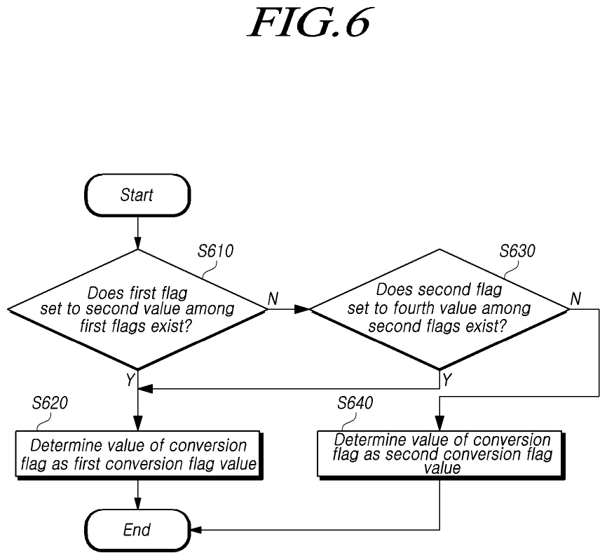

FIG. 6 is a flowchart for describing an operation of the storage device 100 determining the value of the conversion flag CONV_FLG, according to an embodiment of the present disclosure.

In FIG. 6, the controller 120 of the storage device 100 determines whether a first flag set to the second value VAL_2 among the N number of first flags FLG1 exists (operation S610).

When a first flag set to the second value VAL_2 exists (i.e., ‘Y’ in the operation S610), the controller 120 may determine the value of the conversion flag CONV_FLG as a first conversion flag value (operation S620).

On the other hand, when a first flag set to the second value VAL_2 does not exist (i.e., ‘N’ in the operation S610), the controller 120 determines whether a second flag set to the fourth value VAL_4 among the N number of second flags FLG2 exists (operation S630).

When a second flag set to the fourth value VAL_4 exists (i.e., ‘Y’ in the operation S630), the controller 120 may determine the value of the conversion flag CONV_FLG as the first conversion flag value (S620).

On the other hand, when a second flag set to the fourth value VAL_4 does not exist (i.e., ‘N’ in the operation S630), the controller 120 may determine the value of the conversion flag CONV_FLG as a second conversion flag value (operation S640).

That is, when at least one of a first flag set to the second value VAL_2 among the N number of first flags FLG1 and a second flag set to the fourth value VAL_4 among the N number of second flags FLG2 exists, the controller 120 may determine the value of the conversion flag CONV_FLG as the first conversion flag value.

When at least one of a first flag set to the second value VAL_2 and a second flag set to the fourth value VAL_4 exists, a data unit that does not need to be stored in the data area DATA_AREA exists among the N number of data units DU. Therefore, a part of the data area DATA_AREA may be used to store other information instead of the corresponding data unit.

When the values of the N number of first flags FLG1 are all the first value VAL_1 and the values of the N number of second flags FLG2 are all the third value VAL_3, the controller 120 may determine the value of the conversion flag CONV_FLG as the second conversion flag value.

In this case, the first flag set FLG1_SET and the second flag set FLG2_SET may be recovered based on the conversion flag CONV_FLG. This is because the values of the N number of first flags FLG1 included in the first flag set FLG1_SET are all fixed to the first value VAL_1 and the values of the N number of second flags FLG2 included in the second flag set FLG2_SET are all fixed to the third value VAL_3.

The size of the conversion flag CONV_FLG is smaller than the sum of the size of the first flag set FLG1_SET and the size of the second flag set FLG2_SET. Accordingly, by storing the conversion flag CONV_FLG instead of the first flag set FLG1_SET and the second flag set FLG2_SET, the controller 120 may save the storage space of the memory 110.

For example, when the size of the first flag set FLG1_SET is 8 bits and the size of the second flag set FLG2_SET is 8 bits, by storing the conversion flag CONV_FLG of a 1 bit size in the memory 110, the controller 120 may reduce the size of a storage space to be used from 16 bits to 1 bit.

Hereinafter, an operation will be described in which the storage device 100 stores at least one of a) one or more target data units TGT_DU among the N number of data units DU, b) the first flag set FLG1_SET and c) the second flag set FLG2_SET in the data area DATA_AREA depending on the value of the conversion flag CONV_FLG.

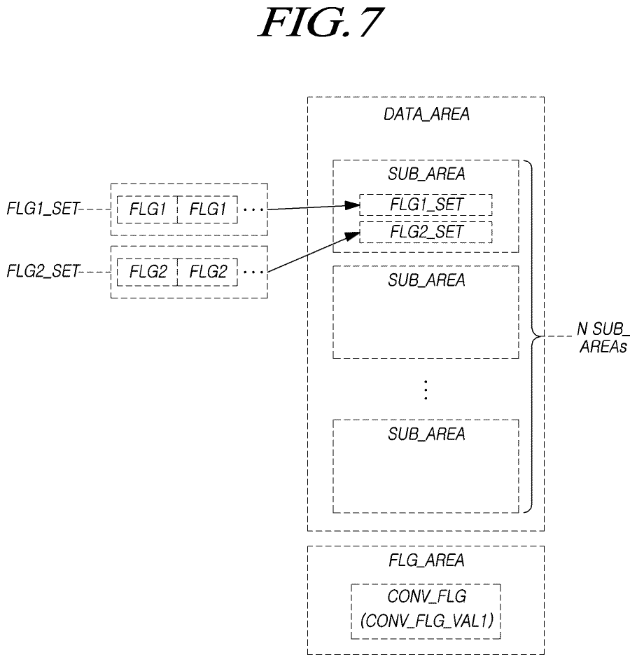

FIG. 7 is a diagram for describing an operation of the storage device 100 storing the first flag set FLG1_SET and the second flag set FLG2_SET in the data area DATA_AREA, according to an embodiment of the present disclosure.

Referring to FIG. 7, the data area DATA_AREA may include N number of sub areas SUB_AREA. The size of each sub area may be the same as the aforementioned size (e.g., 512 bytes) of the data unit DU.

When the value of the conversion flag CONV_FLG is a first conversion flag value CONV_FLG_VAL1, the controller 120 of the storage device 100 may store the first flag set FLG1_SET and the second flag set FLG2_SET in one of the N number of sub areas SUB_AREA.

As described above, a part of the data area DATA_AREA may be used to store other information when the value of the conversion flag CONV_FLG is the first conversion flag value CONV_FLG_VAL1. Accordingly, the controller 120 may use one sub area, which is a part of the data area DATA_AREA, to store the first flag set FLG1_SET and the second flag set FLG2_SET.

Therefore, the controller 120 does not need to use an area other than the data area DATA_AREA to store the first flag set FLG1_SET and the second flag set FLG2_SET. As a result, because a separate storage space for storing the first flag set FLG1_SET and the second flag set FLG2_SET is not needed, the storage space of the memory 110 may be saved.

The controller 120 may additionally store other information in a sub area where the first flag set FLG1_SET and the second flag set FLG2_SET are stored. For example, the controller 120 may additionally store parity information on data units to be stored in the data area DATA_AREA in the corresponding sub area. For another example, the controller 120 may additionally store the number of data units to be stored in the data area DATA_AREA in the corresponding sub area.

For example, the controller 120 may store the first flag set FLG1_SET and the second flag set FLG2_SET in a first sub area among the N number of sub areas SUB_AREA.

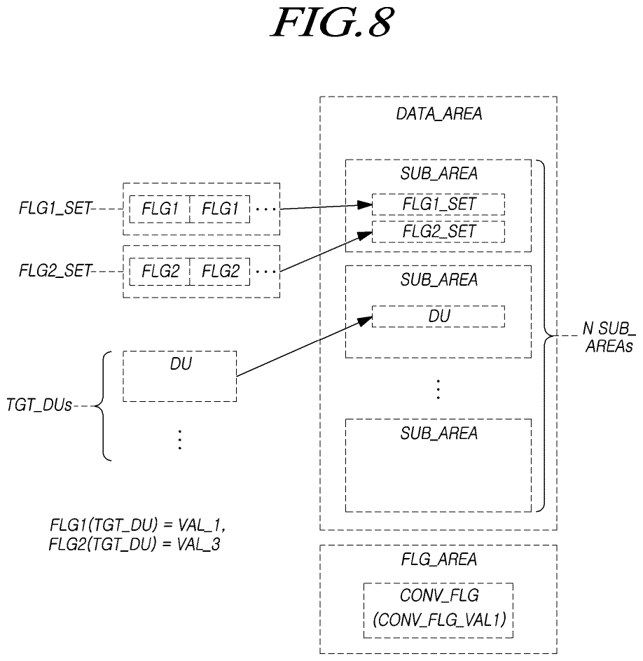

FIG. 8 is a diagram for describing an operation of the storage device 100 storing target data units TGT_DU in the data area DATA_AREA, according to an embodiment of the present disclosure.

Referring to FIG. 8, when the value of the conversion flag CONV_FLG is the first conversion flag value CONV_FLG_VAL1, the controller 120 of the storage device 100 may store target data units TGT_DU in a K-th sub area, where K is a natural number of N or less, K is greater than or equal to 2, and subsequent sub areas of the data area DATA_AREA. This is because, as described above, the first sub area among the N number of sub areas SUB_AREA is used to store the first flag set FLG1_SET and the second flag set FLG2_SET.

At this time, the value of the first flag FLG1 corresponding to each of the target data units TGT_DU is the first value VAL_1, and the value of the second flag FLG2 corresponding to each of the target data units TGT_DU is the third value VAL_3. The target data units TGT_DU are data units that need to respond normally to a read request from the outside of the storage device 100.

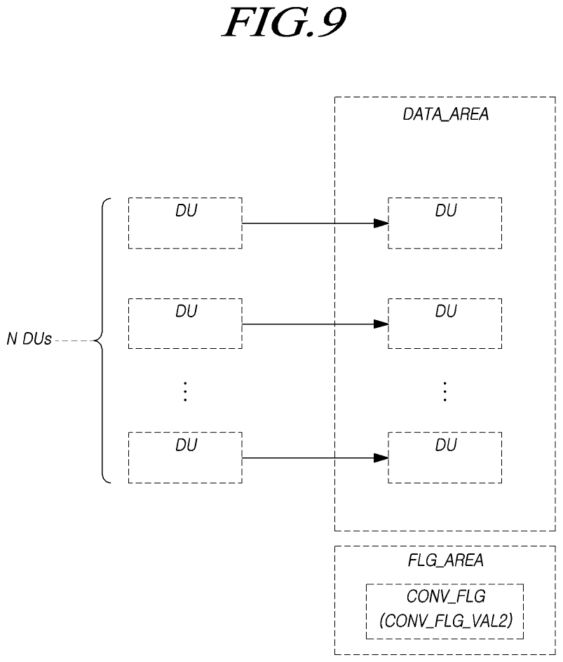

FIG. 9 is a diagram for describing an operation of the storage device 100 storing the N number of data units DU in the data area DATA_AREA, according to an embodiment of the present disclosure.

Referring to FIG. 9, when the value of the conversion flag CONV_FLG is a second conversion flag value CONV_FLG_VAL2, the controller 120 of the storage device 100 may store all of the N number of data units DU in the data area DATA_AREA. This is because all of the N number of data units DU should be processed normally in response to a read request from the outside of the storage device 100.

At this time, the first flag set FLG1_SET and the second flag set FLG2_SET described above are not stored in the data area DATA_AREA. The is because, as described above, based on the fact that the value of the conversion flag CONV_FLG is the second conversion flag value CONV_FLG_VAL2, the controller 120 may be aware that the values of the N number of first flags FLG1 included in the first flag set FLG1_SET are all fixed to the first value VAL_1 and the values of the N number of second flags FLG2 included in the second flag set FLG2_SET are all fixed to the third value VAL_3.

In the above, an operation has been described in which the storage device 100 stores at least one of a) one or more target data units TGT_DU among the N number of data units DU, b) the first flag set FLG1_SET and c) the second flag set FLG2_SET in the data area DATA_AREA.

The operations disclosed in FIG. 7 to FIG. 9 may be performed through a HW accelerator included in the storage device 100 instead of the controller 120.

Hereinafter, an operation will be described in which the storage device 100 restores the first flag set FLG1_SET, the second flag set FLG2_SET and the N number of data units DU based on data stored in the data area DATA_AREA and the flag area FLG_AREA.

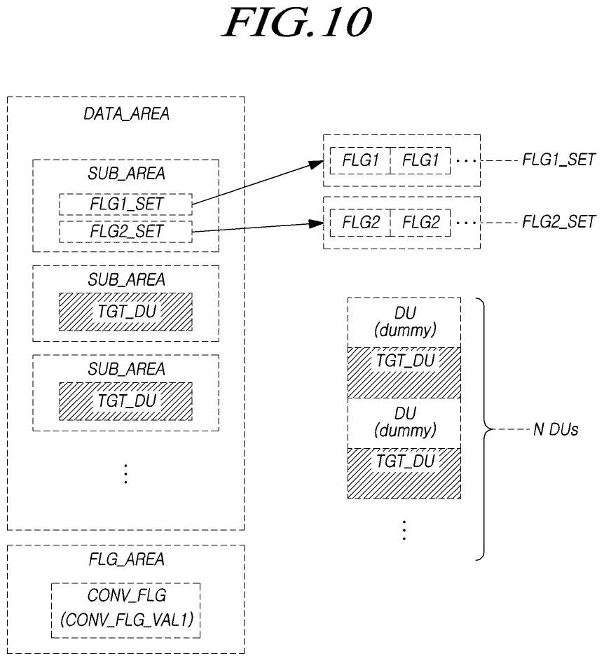

FIG. 10 is a diagram for describing an operation of the storage device 100 restoring the first flag set FLG1_SET, the second flag set FLG2_SET and the N number of data units DU, according to an embodiment of the present disclosure.

Referring to FIG. 10, when the value of the conversion flag CONV_FLG stored in the flag area FLG_AREA is the first conversion flag value CONV_FLG_VAL1, the controller 120 of the storage device 100 may read the first flag set FLG1_SET and the second flag set FLG2_SET from a specific sub area (e.g., the first sub area) among the N number of sub areas SUB_AREA included in the data area DATA_AREA. The corresponding sub area stores the first flag set FLG1_SET and the second flag set FLG2_SET instead of a data unit.

Based on the first flag set FLG1_SET and the second flag set FLG2_SET, the controller 120 may read the target data units TGT_DU stored in the data area DATA_AREA. The number of the target data units TGT_DU stored in the data area DATA_AREA may be determined based on the first flag set FLG1_SET and the second flag set FLG2_SET.

For example, the value of the first flag FLG1 corresponding to each of the target data units TGT_DU stored in the data area DATA_AREA is the first value VAL_1, and the value of the second flag FLG2 corresponding to each of the target data units TGT_DU stored in the data area DATA_AREA is the third value VAL_3.

Therefore, for a natural number I among natural numbers 1 to N, the controller 120 may determine whether a condition that the value of an I-th first flag is the first value VAL_1 and the value of an I-th second flag is the third value VAL_3 is satisfied. The controller 120 may determine that the number of natural numbers satisfying the corresponding condition among the natural numbers 1 to N is the number of the target data units TGT_DU stored in the data area DATA_AREA.

The controller 120 may generate the N number of data units DU based on the first flag set FLG1_SET, the second flag set FLG2_SET and the target data units TGT_DU. Each of the N number of data units DU may be a target data unit read from the data area DATA_AREA or a dummy data unit.

Whether an I-th data unit, where I is a natural number of N or less, among the N number of data units DU is a target data unit or a dummy data unit may be determined based on the first flag set FLG1_SET and the second flag set FLG2_SET.

When the value of the I-th first flag is the first value VAL_1 and the value of the I-th second flag is the third value VAL_3, the I-th data unit among the N number of data units DU is determined as a target data unit. On the other hand, when the value of the I-th first flag is the second value VAL_2 and/or the value of the I-th second flag is the fourth value VAL_4, the I-th data unit among the N number of data units DU is determined as a dummy data unit.

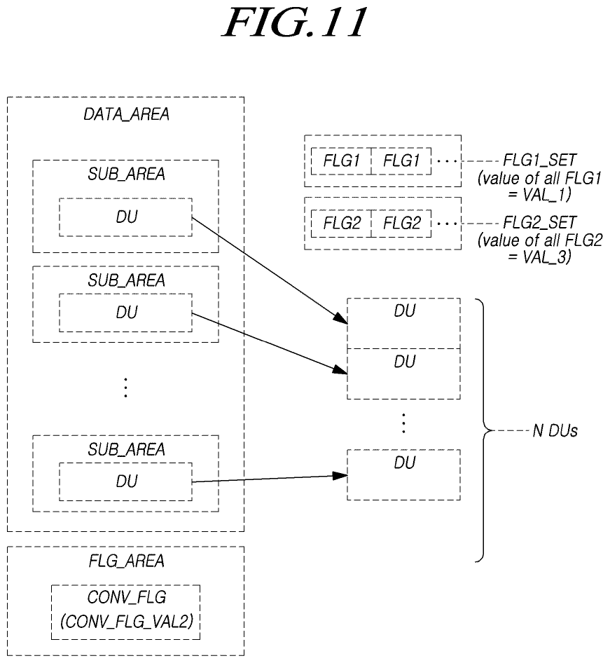

FIG. 11 is a diagram for describing another operation of the storage device 100 restoring the first flag set FLG1_SET, the second flag set FLG2_SET and the N number of data units DU, according to an embodiment of the present disclosure.

Referring to FIG. 11, when the value of the conversion flag CONV_FLG stored in the flag area FLG_AREA is the second conversion flag value CONV_FLG_VAL2, the controller 120 of the storage device 100 may read the N number of data units DU from the data area DATA_AREA.

The controller 120 may generate the first flag set FLG1_SET and the second flag set FLG2_SET. The values of the first flags FLG1 included in the first flag set FLG1_SET are all the first value VAL_1, and the values of the second flags FLG2 included in the second flag set FLG2_SET are all the third value VAL_3.

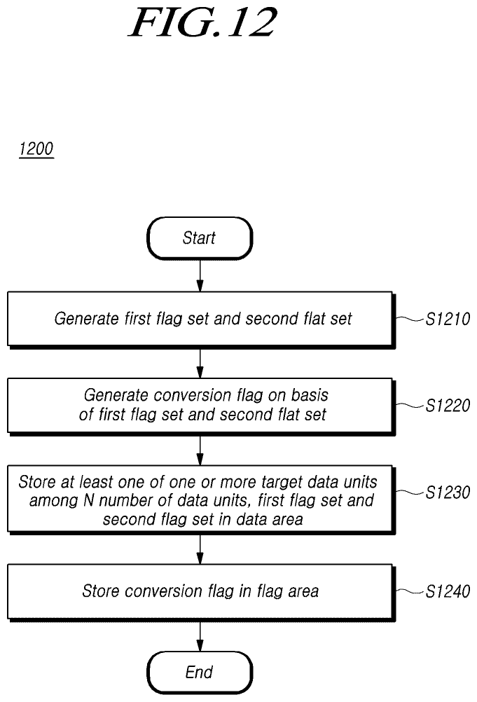

The operations disclosed in FIG. 11 and FIG. 12 may also be performed through the HW accelerator included in the storage device 100 instead of the controller 120.

FIG. 12 is a diagram showing an operating method of the storage device 100 according to an embodiment of the present disclosure.

Referring to FIG. 12, a method 1200 of operating the storage device 100 may include operation S1210 of generating a first flag set FLG1_SET including N number of first flags FLG1, where N is a natural number of 2 or more, corresponding to N number of data units DU, respectively, and a second flag set FLG2_SET including N number of second flags FLG2 corresponding to the N number of data units DU, respectively.

The value of each first flag FLG1 may be a first value VAL_1 or a second value VAL_2. The value of each second flag FLG2 may be a third value VAL_3 or a fourth value VAL_4.

For example, the operation S1210 may set the value of a first flag FLG1 corresponding to a data unit write-requested from the outside of the storage device 100 among the N number of data units DU to the first value VAL_1, and may set the value of a first flag FLG1 corresponding to a data unit not write-requested from the outside of the storage device 100 among the N number of data units DU to the second value VAL_2.

For example, the operation S1210 may set the value of a second flag FLG2 corresponding to a data unit for which a fail does not necessarily need to be responded to a read request from the outside the storage device 100 among the N number of data units DU to the third value VAL_3, and may set the value of a second flag FLG2 corresponding to a data unit for which a fail necessarily needs to be responded to a read request from the outside the storage device 100 among the N number of data units DU to the fourth value VAL_4.

The method 1200 of operating the storage device 100 may include operation S1220 of generating a conversion flag CONV_FLG based on the first flag set FLG1_SET and the second flag set FLG2_SET.

For example, the operation S1220 may determine the value of the conversion flag CONV_FLG as a first conversion flag value CONV_FLG_VAL1 when at least one of a first flag FLG1 set to the second value VAL_2 among the N number of first flags FLG1 and a second flag FLG2 set to the fourth value VAL_4 among the N number of second flags FLG2 exists, and may determine the value of the conversion flag CONV_FLG as a second conversion flag value CONV_FLG_VAL2 when the values of the N number of first flags FLG1 are all the first value VAL_1 and the values of the N number of second flags FLG2 are all the third value VAL_3.

The method 1200 of operating the storage device 100 may include operation S1230 of storing at least one of a) one or more target data units TGT_DU among the N number of data units DU, b) the first flag set FLG1_SET and c) the second flag set FLG2_SET in a data area DATA_AREA.

For example, the data area DATA_AREA may include N number of sub areas SUB_AREA. When the value of the conversion flag CONV_FLG is the first conversion flag value CONV_FLG_VAL1, the operation S1230 may store the first flag set FLG1_SET and the second flag set FLG2_SET in one of the N number of sub areas SUB_AREA. The first flag set FLG1_SET and the second flag set FLG2_SET may be stored in a first sub area among the N number of sub areas SUB_AREA.

The target data units TGT_DU may be stored in a K-th sub area, where K is a natural number of N or less, and subsequent sub areas of the data area DATA_AREA. At this time, the value of the first flag FLG1 corresponding to each target data unit TGT_DU may be the first value VAL_1, and the value of the second flag FLG2 corresponding to each target data unit TGT_DU may be the third value VAL_3.

For another example, when the value of the conversion flag CONV_FLG is the second conversion flag value CONV_FLG_VAL2, the operation S1230 may store all of the N number of data units DU in the data area DATA_AREA.

The method 1200 of operating the storage device 100 may include operation S1240 of storing the conversion flag CONV_FLG in a flag area FLG_AREA corresponding to the data area DATA_AREA.

For example, the flag area FLG_AREA may be an area that stores metadata corresponding to data stored in the data area DATA_AREA.

Although embodiments of the present disclosure have been described for illustrative purposes, those skilled in the art will appreciate that various modifications, additions and substitutions are possible, without departing from the scope and spirit of the present disclosure. Therefore, the embodiments disclosed above and in the accompanying drawings should be considered in a descriptive sense only and not for limiting the technological scope. The technological scope of the present disclosure is not limited by the embodiments and the accompanying drawings. The spirit and scope of the present disclosure should be interpreted in connection with the appended claims and encompass all equivalents falling within the scope of the appended claims. Furthermore, the embodiments may be combined to form additional embodiments.

What is claimed is:

1. A storage device comprising:
a memory including a data area and a flag area corresponding to the data area; and
a controller configured to:
generate a conversion flag based on a first flag set and a second flag set, the first flag set including N number of first flags respectively corresponding to N number of data units, the second flag set including N number of second flags respectively corresponding to the N number of data units, N being a natural number of 2 or more;
store at least one of a) one or more target data units among the N number of data units, b) the first flag set and c) the second flag set in the data area; and
store the conversion flag in the flag area.

2. The storage device according to claim 1, wherein, when each of the N number of first flags has a first value or a second value, the controller is configured to:
set a value of a first flag corresponding to a data unit write-requested from an outside of the storage device, among the N number of data units, to the first value; and
set a value of a first flag corresponding to a data unit not write-requested from the outside of the storage device, among the N number of data units, to the second value.

3. The storage device according to claim 1, wherein, when each of the N number of second flags has a third value or a fourth value, the controller is configured to:
set a value of a second flag corresponding to a data unit for which a fail does not need to be responded to a read request from an outside of the storage device, among the N number of data units, to the third value, and
set a value of a second flag corresponding to a data unit for which a fail needs to be responded to a read request from the outside of the storage device, among the N number of data units, to the fourth value.

4. The storage device according to claim 1, wherein, when each of the N number of first flags has a first value or a second value, and each of the N number of second flags has a third value or a fourth value, the controller is configured to:
determine a value of the conversion flag as a first conversion flag value in response to determination that at least one of a first flag set to the second value among the N number of first flags and a second flag set to the fourth value among the N number of second flags; and
determine a value of the conversion flag as a second conversion flag value in response to determination that the N number of first flags having all the first value and the N number of second flags having all the third value.

5. The storage device according to claim 4,
wherein the data area includes N number of sub areas, and
wherein the controller is configured to store, when the conversion flag has the first conversion flag value, the first flag set and the second flag set in one of the N number of sub areas.

6. The storage device according to claim 5, wherein the controller is configured to store the first flag set and the second flag set in a first sub area among the N number of sub areas.

7. The storage device according to claim 6, wherein
the controller is configured to store the target data units in a K-th sub area and subsequent sub areas of the data area, where K is a natural number of N or less and K is greater than or equal to 2,
wherein the first flag corresponding to each target data unit has the first value, and
wherein the second flag corresponding to each target data unit has the third value.

8. The storage device according to claim 4, wherein the controller is configured to store, when the conversion flag has the second conversion flag value, all of the N number of data units in the data area.

9. The storage device according to claim 1, wherein the flag area is configured to store metadata corresponding to data stored in the data area.

10. An operating method of a storage device, the operating method comprising:
generating a first flag set and a second flag set, the first flag set including N number of first flags respectively corresponding to N number of data units, the second flag set including N number of second flags respectively corresponding to the N number of data units, N being a natural number of 2 or more;
generating a conversion flag based on the first flag set and the second flag set;
storing at least one of a) one or more target data units among the N number of data units, b) the first flag set and c) the second flag set in a data area; and
storing the conversion flag in a flag area corresponding to the data area.

11. The operating method according to claim 10,
wherein each of the N number of first flags has a first value or a second value, and
wherein the generating the first flag set and the second flag set comprises:
setting a value of a first flag corresponding to a data unit write-requested from an outside of the storage device, among the N number of data units, to the first value; and
setting a value of a first flag corresponding to a data unit not write-requested from the outside of the storage device, among the N number of data units, to the second value.

12. The operating method according to claim 10,
wherein each of the N number of second flags has a third value or a fourth value, and
wherein the generating the first flag set and the second flag set comprises:
setting a value of a second flag corresponding to a data unit for which a fail does not need to be responded to a read request from an outside of the storage device, among the N number of data units, to the third value; and
setting a value of a second flag corresponding to a data unit for which a fail needs to be responded to a read request from the outside of the storage device, among the N number of data units, to the fourth value.

13. The operating method according to claim 10,
wherein each of the N number of first flags has a first value or a second value, and each of the N number of second flags has a third value or a fourth value, and
wherein the generating the conversion flag comprises:
determining a value of the conversion flag as a first conversion flag value in response to determination that at least one of a first flag set to the second value among the N number of first flags and a second flag set to the fourth value among the N number of second flags; and
determining a value of the conversion flag as a second conversion flag value in response to determination that the N number of first flags having all the first value and the N number of second flags having all the third value.

14. The operating method according to claim 13,
wherein the data area includes N number of sub areas, and
wherein the storing at least one of a) the target data units, b) the first flag set and c) the second flag set in the data area comprises storing, according to the conversion flag having the first conversion flag value, the first flag set and the second flag set in one of the N number of sub areas.

15. The operating method according to claim 14, wherein the first flag set and the second flag set are stored in a first sub area among the N number of sub areas.

16. The operating method according to claim 15, wherein
the target data units are stored in a K-th sub area and subsequent sub areas of the data area, where K is a natural number of N or less and K is greater than or equal to 2,
wherein the first flag corresponding to each target data unit has the first value, and
wherein the second flag corresponding to each target data unit has the third value.

17. The operating method according to claim 13, wherein the storing at least one of the target data units, the first flag set and the second flag set in the data area comprises storing, in response to determination that the conversion flag having the second conversion flag value, all of the N number of data units in the data area.

18. The operating method according to claim 10, wherein the flag area is configured to store metadata corresponding to data stored in the data area.

19. A storage device comprising:
a data area; and
a flag area configured to store metadata corresponding to data stored in the data area,
wherein the storage device is configured to:
generate a first flag set and a second flag set, the first flag set including N number of first flags respectively corresponding to N number of data units, the second flag set including N number of second flags respectively corresponding to the N number of data units, N being a natural number of 2 or more;
generate a conversion flag based on the first flag set and the second flag set;
store at least one of a) one or more target data units among the N number of data units, b) the first flag set and c) the second flag set in a data area; and
store the conversion flag in a flag area corresponding to the data area.
